(19) United States
(12) Patent Application Publication
(10) Pub. No.: US 2006/0050501 A1
(43) Pub. Date: Mar. 9, 2006

(54) Shroud for gauge pointer

(75) Inventor: Kevin Dyer, Macomb Township, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/186,340

(22) Filed: Jul. 21, 2005

Related U.S. Application Data
(60) Provisional application No. 60/607,401, filed on Sep. 3, 2004.

(51) Int. Cl. G01D 11/28

(52) U.S. Cl. 362/29; 116/288

(57) ABSTRACT

An illuminated instrument assembly includes an instrument cluster having a graphical image and a pointer moveable relative to the graphical image to indicate a vehicle operating condition. In one example, the pointer has a body and an arm portion. A light source illuminates at least a portion of the pointer. The arm portion of the pointer is at least partially coated with a surface finish comprising a metal substrate to eliminate light bleed and the halo effect that may occur when viewing the graphical image.

### BACKGROUND OF THE INVENTION

This application claims priority to U.S. Provisional Patent Application Ser. No. 60/607,401 filed Sep. 3, 2004.

This invention generally relates to an illuminated pointer for an instrument panel, and more particularly to an illuminated pointer that controls light from escaping from an arm portion of the pointer and reflecting onto surrounding surfaces.

A vehicle instrument panel typically includes several gauges for displaying and conveying information to a driver. The instrument panel typically includes a speedometer along with other gauges such as a tachometer, battery level indicator, and oil pressure gauge. Typically a pointer is mounted to move relative to a fixed graphical image on each gauge.

The pointer is typically one of two basic types, either a non-active pointer or an active pointer. A non-active pointer is illuminated by a light source mounted to a circuit board positioned behind a light transparent output shaft. Light is reflected into the pointer and scattered to illuminate the pointer. An active pointer includes a light source secured to the moving pointer.

In each configuration, the pointer includes a body portion that extends from a first end coupled to a motor to a second end that moves relative to the graphical image. One disadvantage with illuminated pointers is that light is often transmitted from the pointer arm to undesirable locations such as toward the viewer. Also, light may reflect onto surrounding gauge surfaces resulting in an undesirable appearance.

Many illuminated pointers include an opaque-plastic shroud attached to the pointer to eliminate undesirable light transmission. Disadvantageously, a plastic shroud requires additional molding and assembly equipment. Further, plastic shrouds are commonly large and bulky which may cause imbalance of the pointer during movement.

Accordingly, it is desirable to provide an illuminated pointer that is easy to assemble and that provides light shrouding without a bulky plastic shroud.

### SUMMARY OF THE INVENTION

An illuminated instrument panel assembly includes a pointer moveable relative to an instrument cluster. The pointer is at least partially coated with a surface finish that prevents undesirable light emissions.

In an example pointer according to this invention, the arm portion of the pointer includes a light emitting surface and an internally light reflecting surface. The internally light reflecting surface includes a surface finish applied using a vacuum metallizing process. The light emitting surface does not include the surface finish. In one example, the assembly includes a light source to illuminate at least a portion of the pointer. The illumination exits the pointer only through the light emitting surface of the arm portion of the pointer to light the graphical image.

The illuminated instrument assembly of the present invention provides a surface finish for an illuminated pointer that is simple to apply and provides a compact appearance.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates an instrument cluster including a pointer assembly according to the present invention;

FIG. 2 shows a perspective view of an example pointer with an exemplary surface finish shroud according to the present invention;

FIG. 3 is a perspective view of a bottom side of the pointer with the surface finish shroud according to the present invention;

FIG. 4 is a flow chart illustrating a process for providing a surface finish on a pointer according to the present invention; and

FIG. 5 is a cross-sectional view of an example gauge pointer assembly including the pointer with the surface finish shroud.

### DETAILED DESCRIPTION OF THE PREFERRED EMBODIMENT

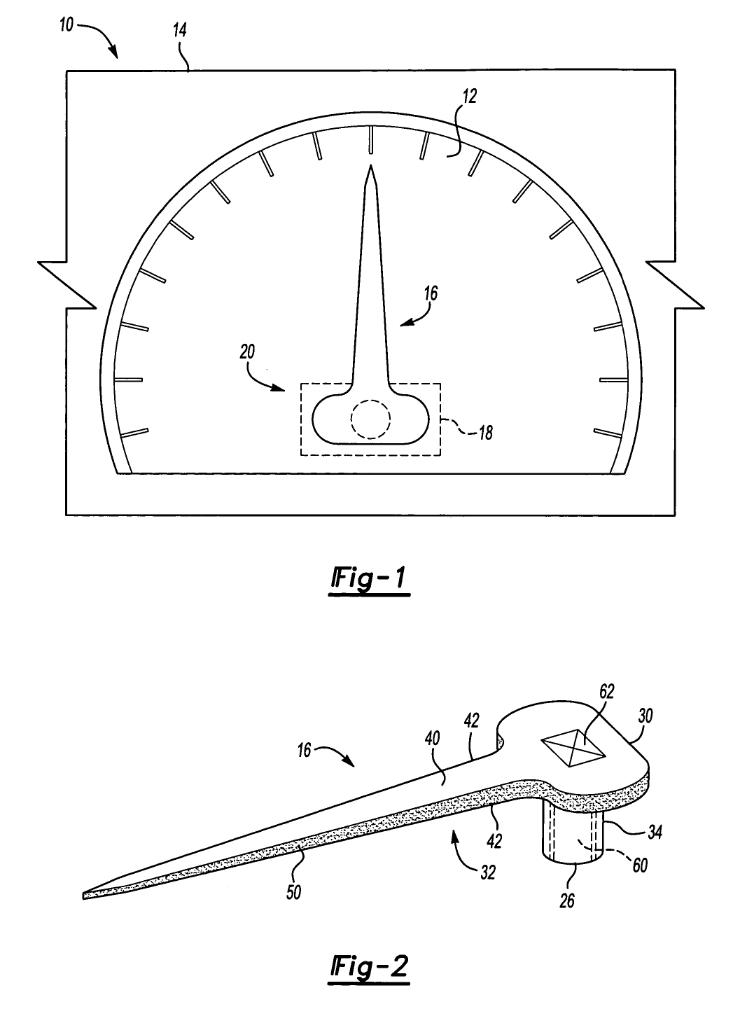

An instrument cluster 10 including at least one gauge pointer assembly 20 is shown generally in FIG. 1. The instrument cluster 10 includes a gauge 12 having a graphical image, such as a scale, for example, which is used to indicate a vehicle operating condition. The gauge 12 is mounted to a dash panel or other similar fixed vehicle structure 14. A pointer 16 is mounted for movement relative to the gauge 12 and is used to indicate the current status of the vehicle operating condition. A light source 18 is mounted behind the instrument cluster 10 and is used to illuminate at least a portion of the pointer 16 so that a vehicle operator can clearly see the vehicle operating condition. The light source 18 can illuminate the length of the pointer 16, only the tip of the pointer 16, or any portion thereof. The light source 18 is a light emitting diode [LED]. It is within the contemplation of this invention to utilize any other light source known in the art.

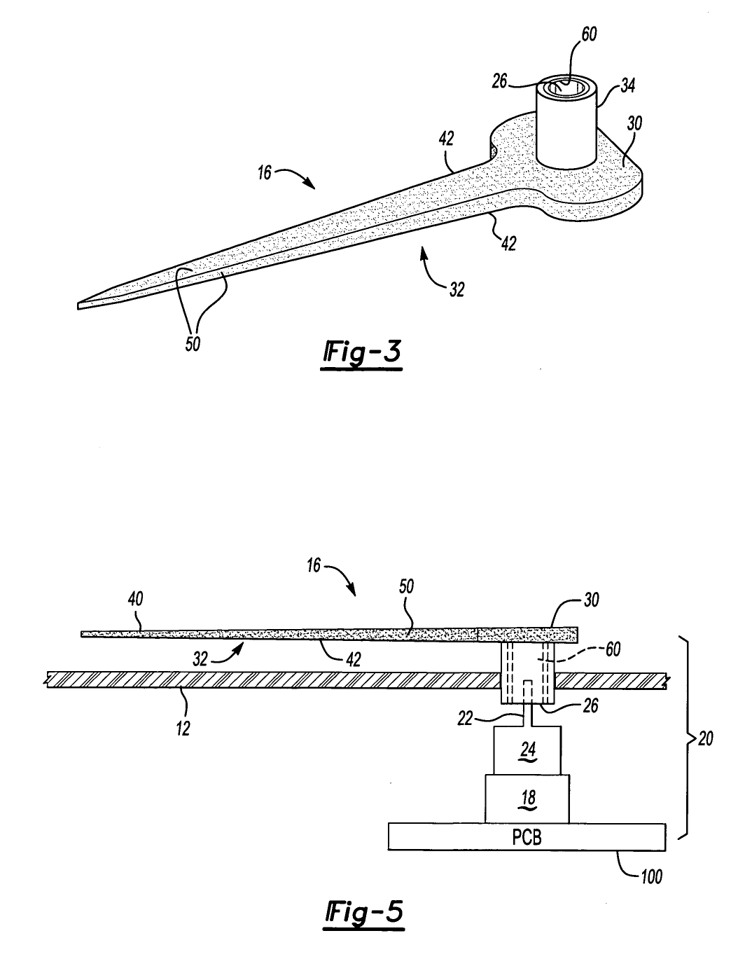

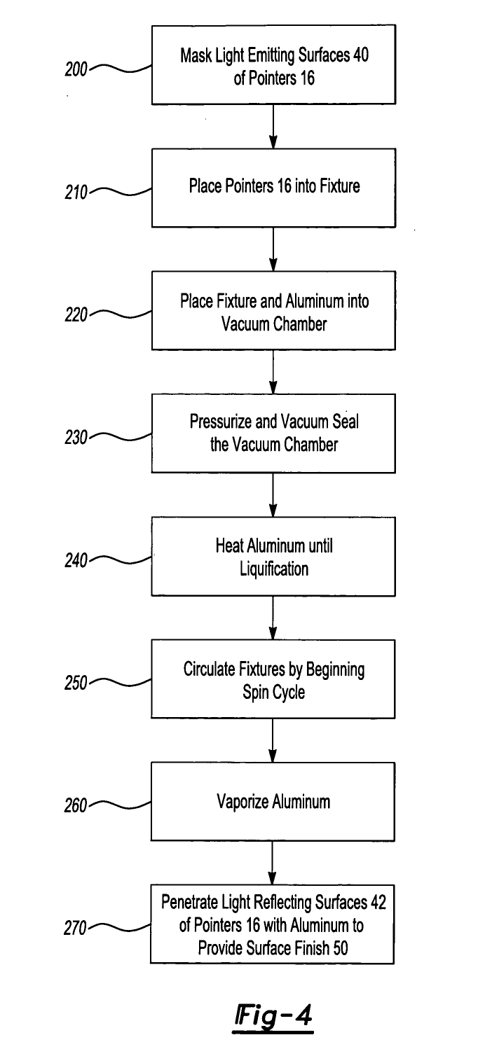

An example pointer 16 for use within the gauge pointer assembly 20 is illustrated with reference to FIGS. 2 and 3. The pointer 16 includes a body 30 and an arm portion 32. The body 30 includes a shaft 34 protruding transverse to the arm portion 32. In one example, the shaft 34 is perpendicular to the arm portion 32. The shaft 34 includes an opening 26 for receiving an output shaft 22 of a motor 24 (See FIG. 4).

The arm portion 32 of the pointer 16 includes a light emitting surface 40 and a plurality of internally light reflecting surfaces 42. The light emitting surface 40 preferably faces the direction of a driver in a passenger compartment of a vehicle. The arm portion 32 of the pointer 16 includes one light emitting surface 40 and three internally light reflecting surfaces 42 to form a four-sided arm portion 32. The arm portion 32 could be comprised of additional numbers of surfaces.

The plurality of internally light reflecting surfaces 42 are coated during a secondary process with a surface finish shroud 50. The surface finish shroud 50 is preferably applied through a vacuum metallized process. The surface finish shroud may also be applied through other known processes such as by painting or chrome plating, for example.

With reference to FIG. 4, a process for coating a pointer 16 through a vacuum metallization process is demonstrated. The process begins by masking the light emitting surfaces 40 of a plurality of pointers 16 as indicated at 200. The pointers 16 may be masked in any known manner to prevent the surface finish shroud 50 from being applied to the light emitting surface 40. The plurality of pointers 16 are placed into a fixture as indicated at 210. Advantageously, a large amount of pointers 16 may be coated with the surface finish shroud 50 simultaneously. The fixture is then placed inside of a vacuum chamber as indicated at 220 along with an amount of nearly pure aluminum. The vacuum chamber is then pressurized and vacuum sealed as indicated at 230.

Next, the aluminum is heated until it liquefies as indicated at 240. As the aluminum liquefies and begins to flow, the vacuum chamber enters a spin cycle as indicated at 250. The spin cycle circulates the fixtures within the vacuum chamber such that all parts within the fixtures are properly exposed to the aluminum. The aluminum begins to vaporize as indicated at 260, and upon contacting the pointers 16, the vaporized aluminum molecules penetrate the light reflecting surfaces 42 of the pointers 16 to provide the surface finish shroud 50 as indicated at 270. The light emitting surface 40 of the pointer 16 will not include the surface finish shroud 50 because the light emitting surface 40 is masked prior to the vacuum metallization process.

Referring to FIG. 5, a light receiving tube 60 is received within the opening 26 of the shaft 34 of the body 30. The light receiving tube 60 receives light from the light source 18 and communicates the light to a light reflecting surface 62 (FIG. 2) within the body 30. The light reflecting surface 62 provides internal reflection. In one example, the light receiving tube 60 is a clear, hollow shaft. The light received within the light receiving tube 60 is reflected off of the light reflecting surface 62 into the arm portion 32. The light reflecting surface 62 comprises flat surfaces angled at 45°. A worker skilled in the art would understand how to configure the length, angle and shape of the light reflecting surface 62 to direct light along a desired path through the arm portion 32 of the pointer 16. The light emitting surface 40 does not include the surface finish shroud 50. Therefore, as light from the light source 18 is emitted through the light receiving tube 60 and into the arm portion 32 of the pointer 16, the light escapes only through the light emitting surface 40 and is prevented from escaping through the internally light reflecting surfaces 42. The light that attempts to leak through the internally light reflecting surfaces 42 is reflected back toward the light emitting surface 40.

In operation, the opening 26 of the shaft 34 of the pointer 16 is received on the output shaft 22 of the motor 24 in an interference fit, however other attachment methods could be used. The pointer 16 is driven by the motor 24 and is rotated to a desired position relative to the gauge 12 including the graphical image.

The pointer 16 is illuminated by the light source 18 that is mounted behind the instrument cluster 10. In one example, the light source 18 is mounted to a printed circuit board (PCB) 100 and positioned adjacent to the motor 24. The output shaft 22 of the motor 24 is preferably a translucent shaft. Therefore, the light that is emitted from the light source 18 passes through the output shaft 22 and enters the pointer 16 through the light receiving tube 60, where light is propagated and scattered into the arm portion 32 to illuminate the gauge 12. The light exits only through the light emitting surface 40 of the arm portion 32.

The present invention improves upon the prior art by providing an illuminated gauge pointer assembly 20 that includes a surface finish shroud 50 on at least a portion of the pointer 16. The surface finish shroud 50 may be applied by a vacuum metallization process which provides the benefits of a less costly shrouding process and the ability to shroud a multitude of pointers 16 simultaneously. The surface finish shroud 50 effectively eliminates light bleed from the pointer 16 (without a bulky appearance) that may occur when viewing the gauge 12.

The foregoing shall be interpreted as illustrative and not in a limiting sense. A worker of ordinary skill in the art would recognize that certain modifications would come within the scope of this invention. For that reason, the following claims should be studied to determine the true scope and content of this invention.

What is claimed is:

1. An illuminated instrument assembly, comprising:
an instrument cluster having at least one graphical image indicating a vehicle operating condition; and
a pointer moveable relative to said graphical image, said pointer at least partially coated with a surface finish comprising a metal substrate.

2. The assembly as recited in claim 1, wherein said surface finish includes a vacuum metallized finish.

3. The assembly as recited in claim 1, wherein said surface finish includes a painted finish.

4. The assembly as recited in claim 1, wherein said surface finish includes a chrome plated finish.

5. The assembly as recited in claim 1, wherein said pointer includes a body having a shaft positioned transverse to an arm, said shaft being operably coupled to a power source to move said pointer relative to said graphical image.

6. The assembly as recited in claim 5, comprising a light source, wherein said shaft directs light from said light source toward a light reflecting surface into said arm to illuminate said pointer.

7. The assembly as recited in claim 6, wherein said arm includes a light emitting surface and an internally light reflecting surface.

8. The assembly as recited in claim 7, wherein said internally light reflecting surface is coated with said surface finish such that light exits said pointer only through said light emitting surface.

9. An illuminated instrument assembly comprising:
an instrument cluster having at least one graphical image indicating a vehicle operating condition;
a pointer moveable relative to said graphical image, said pointer comprising an arm portion having a light emitting surface and a light reflecting surface, wherein said light reflecting surface is coated with a surface finish comprising a metal substrate; and
a light source that provides illumination to said pointer, wherein a portion of light is directed through said pointer to light said graphical image.

10. The assembly as recited in claim 9, including a shaft positioned transverse to said arm portion, said shaft including a light receiving tube, said shaft operably coupled to a power source to move said pointer relative to said graphical image.

11. The assembly as recited in claim 10, wherein said power source includes a motor having a translucent shaft, wherein said light source communicates light through said translucent shaft and into at least a portion of said pointer.

12. The assembly as recited in claim 9, wherein light is reflected into said arm portion and exits said pointer through said light emitting surface only.

13. The assembly as recited in clam 9, wherein said surface finish includes a vacuum metallized finish.

14. The assembly as recited in claim 9, wherein said surface finish includes a painted finish.

15. The assembly as recited in claim 9, wherein said surface finish includes a chrome plated finish.

16. A method of providing a shrouded pointer comprising the steps of:
(a) masking at least a portion of a pointer arm;
(b) placing the pointer arm in a vacuum chamber and vacuum sealing the chamber;
(c) evaporating a metal; and
(d) penetrating a portion of the pointer arm without the mask with the evaporated metal to coat at least a portion of the pointer arm with a surface finish comprising the metal.

17. The method as recited in claim 16, wherein said step (a) includes masking a light emitting surface of the pointer arm only.

18. The method as recited in claim 16, wherein the metal comprises aluminum.

19. The method as recited in claim 16, wherein said step (d) includes penetrating a plurality of internally light reflecting surfaces with the evaporated metal.

20. The method as recited in claim 16, further comprising the step of:
(e) mounting the pointer arm relative to a graphical image and illuminating the pointer arm with a source of light.
